(19) United States
(12) Patent Application Publication
(10) Pub. No.: US 2025/0076924 A1
(43) Pub. Date: Mar. 6, 2025

(54) Adjustable Gadget Holding Device

(71) Applicant: Yuzuru Ito, Plymouth, MI (US)

(72) Inventor: Yuzuru Ito, Plymouth, MI (US)

(21) Appl. No.: 18/633,233

(22) Filed: Apr. 11, 2024

Related U.S. Application Data
(60) Provisional application No. 63/620,855, filed on Jan. 14, 2024.
(60) Provisional application No. 63/616,613, filed on Dec. 30, 2023.
(60) Provisional application No. 63/536,432, filed on Sep. 3, 2023.

(51) Int. Cl. G06F 1/16

(52) U.S. Cl. CPC G06F 1/1628; G06F 1/1618

(57) ABSTRACT

An adjustable protective device for smartphones and tablets comprises of a protective case having an inner compartment for accommodating a gadget like smartphone or tablet and an outer portion in view of providing protection against potential damage. The device comprises a foldably connected screen cover comprising plurality of members including a base member, support member, a connecting member, a first and second additional member that are foldably connected via a plurality of fold lines for covering a screen of the gadget. A plurality of raised-position support components are configured with the protective case and the plurality of members for achieving stable typing angle and wide range of viewing angle, and at least one stabilizer extension configured on the base member that provides additional stability when the protective case is used as a stand. The screen cover is detachable from the protective case through at least a lip.

### CROSS-REFERENCE TO RELATED PATENT APPLICATION

This disclosure claims the benefit of the priority of U.S. Provisional Patent Application No. 63/620,855, entitled “Tablet smartphone cover” and filed on Jan. 14, 2024; Application No. 63/616,613 entitled “Tablet smartphone cover” and filed on Dec. 30, 2023; Application No. 63/536,432 entitled “Tablet smartphone cover” and filed on Sep. 3, 2023. All the above-identified applications are incorporated herein by reference in its entirety.

### TECHNICAL FIELD

The present invention relates to an adjustable gadget holding device and more particularly to an adjustable protective device for electronic gadget such as smartphone and tablet that is capable of being utilized as a stand, which provides wide range of viewing angles and typing angle for ergonomic usage of smartphone and tablets.

### BACKGROUND OF THE INVENTION

There are plenty of smartphones and tablet devices available everywhere. Due to the fact that smartphones and tablets are somewhat costly, people often use covers or cases that are designed to keep them safe without hindering use. The existing cases or covers generally focus on providing protection from breakage, dust, humidity and other environmental factors that may damage smartphone and tablet devices.

Currently, the available cover or case does not allow the user to protect and personalize their devices by enabling the user to position the devices for viewing in either portrait or landscape orientation, leading to suboptimal user experiences. The available cover or case that provide built-in stand have limited adjustability of viewing angle and are somewhat bulky and heavy, which hinders the user's productivity.

In one of the prior art, US20160028429A1 discloses a smart case with features including one or more of a locking door, flip ID, collapsible compartment, magnetic release and/or mechanical release to access ID, lanyard boss, tripod, programmable tactile buttons, wide/zoom camera lenses, keyless vehicle fob, fitness technology, lipstick/pen holder, retractable ear buds, magnetic card reader, battery, USB port, recharging technology, wireless charging receiver and tracking technology. A microchip, microcontroller, controller or processor with embedded or separate memory is configured or programmed to control the smart electronic features. Although, this particular prior art discloses the smart case for mobile devices that is capable of providing protection. However, the above-mentioned prior art lacks in flexibility to provide desirable viewing and typing angle.

In another prior art, U.S. Pat. No. 8,230,992B2 discloses to a case or cover for an electronic device such as a tablet computer is disclosed. This case allows the user to protect and personalize their tablet computer. The case allows the user to position the device for viewing in either portrait or landscape mode and does not require the user to hold the device in the desired orientation. The case may have a distinct hinge, with a stop that limits its rotational travel allowing the user to prop the electronic device up, at a desired viewing angle. Although, the mentioned art allows the user to change orientation to portrait or landscape. However, offers limited orientation change, which hinders the user from performing desirable operation.

Conventionally, many tools and devices available in the market that is capable of protecting electronic gadget, holding the gadget at a particular angle and even offers change in orientation. However, these tools and devices provide only limited adjustability in viewing angle and personalization.

To overcome the above-mentioned shortcoming, an improved protecting cover is being introduced that is capable of protecting the gadget from potential damages, holding the gadget at multiple angle and orientation to provide convenience to the user and give personalized experience to the user.

### OBJECTS OF THE INVENTION

The principal object of the present invention is to overcome the disadvantages of the prior art and to provide an adjustable gadget holding device that protects the gadgets like smartphones and tablets from adverse environmental factors, which leads to potential damages.

Another object of the present invention is to provide a device that is capable of holding the gadget at user-desirable typing angle along with enabling adjustment in wide range of viewing angle.

Yet another object of the invention is to provide a lightweight cover and stable stand for ease of use.

The foregoing and other objects, features, and advantages of the present invention will become readily apparent upon further review of the following detailed description of the preferred embodiment as illustrated in the accompanying drawings.

### SUMMARY OF THE INVENTION

This present invention relates to an adjustable protective device for smartphone and tablets that protects a gadget like smartphone and tablet from potential damages, and provides wide range of adjustability of viewing angles, enhanced stability to improve ergonomic usage of the gadget.

In accordance with a preferred embodiment, an adjustable protective device for smartphones and tablets comprise of a protective case comprising an inner compartment and an outer portion, a foldably connected screen cover for covering a screen of the smartphone or tablet device. Herein, “foldably connected” refers to ability to be folded or bent while maintaining a functional connection. The folding or bending of the screen cover with respect to the protective case allows a user to accomplish a close and open position. The screen cover is fully collapsible to cover the screen of the smartphone or tablet. The folding of the screen cover also aids in supporting the back of the protective case. The foldable connection includes but not limited to detent mechanism, locking mechanism, magnetic clasp or hinge mechanism. The protective case allows the user to accommodate the smartphone or tablet in a secure manner. The screen cover comprises a plurality of members, which includes a base member, support member, and connecting member that are foldably connected with each other to allow covering of the screen of the gadget such as smartphone or tablet or other identical devices accommodated within the protective case in view of protecting the gadget from potential damages as well as providing support to the back of the protective case.

The base member, the support member, and the connecting member are foldably connected with each other via a plurality of fold lines. The protective case and the base member, the base member and the support member, and the support member and the connecting member are respectively connected at a first fold line, a second fold line and a third fold line. The plurality of fold lines of the screen cover allows adjustability of a wide range of viewing angles for the protective case and a greater stability for a raised position of the protective case by means of at least one stabilizer extension configured at the base member. The pluralities of members are stabilized at a plurality of angles on the back of the protective case for the wide range of viewing angles. Moreover, the invention discloses a plurality of raised-position support components configured independently with the outer portion of the protective case and connecting member. In one of the embodiment, the plurality of raised support components are configured in at any location or throughout the area of protective case and the connecting members. In other embodiment, the plurality of raised-position support components are configured in any at least one of the plurality of members or all of the plurality of members including additional members. In one of the embodiment, the plurality of raised-position support components comprising magnets are configured at the edges of the plurality of members along the at least one fold line. The plurality of raised-position support components comprises a plurality of magnets and a plurality of magnet-attractable parts that are connected by a user for achieving stable typing angle and wide range of viewing angle.

According to an aspect of the embodiment of the present invention, the raised-position support components disclose a hook and loop fasteners, such the protective case is configured with hook fasteners and the connection member configured with the loop fastener(s). The user is able to achieve wide range of viewing angle by changing the point of contact of hook and loop fastener. In one of the embodiments, the plurality of raised-position support components is configured along the edges of the plurality of members including additional members along the either sides of the least a fold line.

According to an embodiment of the present invention, the invention discloses that the base member with the stabilizer extension which provides additional stability when used as a stand. The cover portion consists of three or more members which are foldably connected for aiding the user to adjust the viewing angle as per their desire.

According to one of the embodiments, a protective case for smartphone or tablet device, the protective case comprising a foldably connected screen cover for covering smartphone or tablet device screen, the screen cover comprises a plurality of members, the plurality of members includes a base member, a support member and a connecting member, wherein the base member, the support member and the connecting member are foldably connected to each other via a plurality of fold lines, wherein the plurality of fold lines of the screen cover allows adjustability ofa wide range of viewing angles for the protective case encasing the smartphone or tablet and a greater stability for a raised position of the protective case. Further, greater stability of the protective case is achieved with at least one stabilizer extension configured in the base member, wherein the plurality of members are stabilized at a plurality of angles on the back of the protective case for the wide range of viewing angles, and the stabilization of the screen cover on the back of the protective case is achieved by a plurality of raised-position support components.

In another alternate embodiment, the screen cover further comprises at least one additional member between the base member and the support member. In one of the embodiments, the screen cover comprises at least two additional members including a first additional member and a second additional member configured between the base member and the support member. The first additional member and the second additional members are narrow members having shorter breadth and longer length. In all the embodiments having the additional member, the at least one stabilizer extension of the base member provides more stability when used as a stand. Moreover, the stabilizer extension forms a double rabbet or scarf type interlocking while the stabilizer mates with the plurality of additional members and/or the support member. In one of the embodiments, the at least one stabilizer extension forms an interlocking with the plurality of additional members and/or the support member to keep the stabilizer extension on the same plane as the base member and/or the additional members exists.

In other embodiment, the support member is always above the plane of the stabilizer extension to provide strong standing support to the device for stable viewing angle.

According to an exemplary embodiment, the double rabbet or scarf type interlocking is configured in at least one additional member and a support member. The interlocking configured in the stabilizer extension edges and the additional members prevent the stabilizer extension to flip over other side of the support members and additional members while mates at the point of mating. The interlocking between at least one stabilizer extension and the plurality of additional members and/or the support member prevents flipping of the stabilizer extension against the support member and/or the additional members at the point of mating.

In an embodiment, the screen cover is detachable from the protective case through at least a lip and the screen is two ways foldable i.e. one way is to cover the screen of the smartphone or tablet and other way is to fold backward to provide various viewing angle stand for reading or typing. The lip allows direct attachment of the screen cover with the smartphone or the tablet. In one of the embodiments, the plurality of raised-position support components is configured in the smartphone or the tablets. The plurality of raised-position support components configured in the connecting members allows adjustability of the wide range of viewing angles to the smartphone or the tablet by means of the at least one lip configured in the screen cover. In an embodiment, the base member, the support member and the connecting member form a triangular structure when folded and provide a standing raised position to the protective case. In the embodiment, the protective case and the base member, the base member and the support member, and the support member and the connecting member are respectively connected at a first fold line, a second fold line and a third fold line. Each fold lines provide flexibility to fold and hold the protective case at various viewing angles.

In an embodiment, a plurality of raised-position support components is provided which includes a magnet, a ferromagnetic material and a magnet-attractable part, and hook-and-loop fasteners. In the embodiment, the plurality of raised-position support components comprises at least one magnet in the protective case and at least a magnet-attractable-part in the connecting member. In the embodiment, the viewing angle of the protective case is adjusted by changing at least a contact point of the plurality of raised-position support components of the connecting member on the protective case. In an alternate embodiment, the plurality of raised-position support components comprises a plurality of protrusions on the connecting member and a plurality of pockets on a back side of the protective case. In the embodiment, the variable view angle is obtained when at least a pair of the plurality of protrusions is inserted in at least a pair of the plurality of pockets on the back of the protective case. In an alternate embodiment, the plurality of raised support components configured in the protective case and the plurality of members forms a pairing between the corresponding magnets and magnet attachable parts in order to have stability at an angle to provide viewability of the protective case for the smartphone or tablet.

In one of the embodiments, the base member comprises interlocking edges on the stabilizer extension providing one-way movements of the member with a mating edge of the support member. In another embodiment, the connecting member has an edge, and the protective case has a groove line; the edge inserted into the groove line to stabilize the protective case at low angle to allow typing angle. In one of the alternate embodiments, the connecting member is folded alternatively downward resting at the bottom of the protective case and connected together with the plurality of raised-position support components for providing stability at the standing position.

While the invention has been described and shown with particular reference to the preferred embodiment, this will be apparent that variations might be possible that would fall within the scope of the present invention.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below.

To further clarify advantages and features of the present invention, a more particular description of the invention will be rendered by reference to specific embodiment thereof, which is illustrated in the appended drawings. It is appreciated that these drawings depict only typical embodiments of the invention and are therefore not to be considered limiting of its scope. As will be appreciated, other embodiments of the present invention are possible utilizing, alone or in combination, one or more of the features set forth above or described in detail below.

### BRIEF DESCRIPTION OF THE DRAWINGS

These and other features, aspects, and advantages of the present invention will become better understood with regards to the following description, appended claims, and accompanying drawings wherein:

FIG. 1 illustrates an isometric view of the preferred embodiment of the present invention from the back, showing folded cover portion supporting the back of the protective case;

FIG. 2 illustrates an isometric view of the preferred embodiment of the present invention from the back, depicting laying orientation of cover portion;

FIG. 3 illustrates a front view of the cover portion with the cover portion at closed position of the preferred embodiment of the present invention;

FIG. 4 illustrates a side view of the preferred embodiment of the present invention with the cover portion at closed position;

FIG. 5 illustrates a front view of the preferred embodiment of the present invention with the cover portion at open position;

FIG. 6-9 illustrates a side view of the folded cover portion supporting the back of the protective case providing different viewing angle of the preferred embodiment of the present invention;

FIG. 10 illustrates an isometric view of the first alternate embodiment of the present invention, depicting the folded cover supporting the back of the protective case;

FIG. 11 illustrates an isometric view of the first alternate embodiment of the present invention, indicating the cover portion lying flat on a table;

FIG. 12 illustrates a side view of the first alternate embodiment of the present invention;

FIG. 13 illustrates an isometric view of the first alternate embodiment of the present invention at typing angle;

FIG. 14 illustrates a cross section x-x′ shown in FIG. 13, circle area AAA′ at groove 206a and edge of the third member, 206b apart;

FIG. 15 illustrates an isometric view of the second alternate embodiment of the present invention, showing the protective case, 300a of the second alternate embodiment of the present invention and the cover portion, 300b of the second alternate embodiment of the present invention;

FIG. 16 illustrates a side view of the second alternate embodiment of the present invention at the typing angle;

FIG. 17 illustrates an isometric view of the third alternate embodiment of the present invention from the back, indicating an alternate design of the extension on the base member;

FIG. 18 illustrates an isometric view of the fourth alternate embodiment of the present invention from the back, indicating an alternate folding direction of the connecting member of the cover;

FIG. 19 illustrates an isometric view of the fourth embodiment of the present invention, indicating cover portion lying on the table;

FIG. 20 illustrates a side view of the fourth embodiment of the present invention with an alternative folding direction of the connecting member of the cover portion, indicated through an arrow 2000 shown in FIG. 18;

FIG. 21 illustrates an isometric view of the fifth alternate embodiment of the present invention, depicting the folded cover portion supporting the back of the protective case;

FIG. 22 illustrates a side view of the fifth alternate embodiment of the present invention, indicating the cover portion in folded configuration to generate the largest viewing angle EE;

FIG. 23 illustrates a side view of the fifth alternate embodiment of the present invention, indicating the cover portion in folded configuration to generate reduced viewing angle EE than the angle shown in FIG. 22;

FIG. 24 illustrates a side view of the fifth alternate embodiment of the present invention as shown in an arrow 3000 in FIG. 21, indicating the cover folding configuration to generate reduced viewing angle than EE, shown in FIG. 23;

FIG. 25 illustrates a side view of the fifth alternate embodiment of the present invention, depicting the cover portion in folded configuration to generate reduced viewing angle EE than the configuration shown in FIG. 24;

FIG. 26 illustrates a side view of the fifth alternate embodiment of the present invention, depicting the cover portion in folded configuration to generate reduced viewing angle EE than the configuration shown in FIG. 25;

FIG. 27 illustrates a side view of the fifth alternate embodiment of the present invention, depicting the cover portion in folded configuration to generate reduced viewing angle EE than the configuration shown in FIG. 26, indicating the writing angle;

FIG. 28 illustrates an isometric view of the sixth alternate embodiment of the present invention, showing the folded cover portion supporting the back of the protective case, indicating the alternate locking design to support the back of the protective case;

FIG. 29 illustrates an isometric view of the sixth alternate embodiment of the present invention, indicating the cover portion lying on the table;

FIG. 30 illustrates an isometric view of the seventh alternate embodiment of the present invention, indicating the folded cover portion supporting the back of the protective case;

FIG. 31 illustrates an isometric view of the eighth alternate embodiment of the present invention, indicating the folded cover portion supporting the back of the protective case;

FIG. 32 illustrates an isometric view of the ninth alternate embodiment of the present invention, indicating the folded cover portion supporting the back of the protective case;

FIG. 33 illustrates a side view of the ninth alternate embodiment of the present invention as shown in arrow 4000 in FIG. 32, indicating the viewing angle GG is larger than the viewing angle HH shown in FIG. 40;

FIG. 34 illustrates a cross-section Y-Y′ shown in FIG. 32 of the ninth alternate embodiment of the present invention;

FIG. 35 illustrates a side view of EEE′ is an exploded view of the area EEE as shown in FIG. 33;

FIG. 36 illustrates an exploded view of circled area BBB, shown in FIG. 32;

FIG. 37 illustrates an exploded view of circled area CCC, shown in FIG. 32;

FIG. 38 illustrates an exploded view of circled area DDD, shown in FIG. 32;

FIG. 39 illustrates an isometric view of the ninth alternate embodiment of the present invention, indicating the folded cover portion supporting the back of the protective case;

FIG. 40 illustrates a side view of an arrow 5000, shown in FIG. 39, indicating the viewing angle HH is smaller than the viewing angle GG shown in FIG. 32;

FIG. 41 illustrates a cross-section of Z-Z′ shown in FIG. 39;

FIG. 42 illustrates an exploded view of the circled area FFF in FIG. 41; and

FIG. 43 illustrates an exploded view of an alternate design of the circled area FFF shown in FIG. 41.

### DETAILED DESCRIPTION OF THE INVENTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

Unless otherwise defined, all technical and scientific terms used herein have the same meaning as commonly understood by one of ordinary skill in the art to which this invention belongs. The present invention disclosed herein is illustrative only and not intended to be limiting.

Embodiments of the present invention will be described below in detail with reference to the accompanying drawings.

The present invention is related to an adjustable protective device for smartphones and tablets that is capable of accommodating different types of an electronic gadget such as smartphones and tablets in a secure grip and orients the gadget at a user-desired angle, which provide convenience to the user while using the gadget. Moreover, the device is useful for protecting the gadget from adverse environmental and accidental factors, which may cause damage to the gadget. The disclosed invention allows the user to adjust the viewing angle in accordance with their requirement for providing a personalized experience.

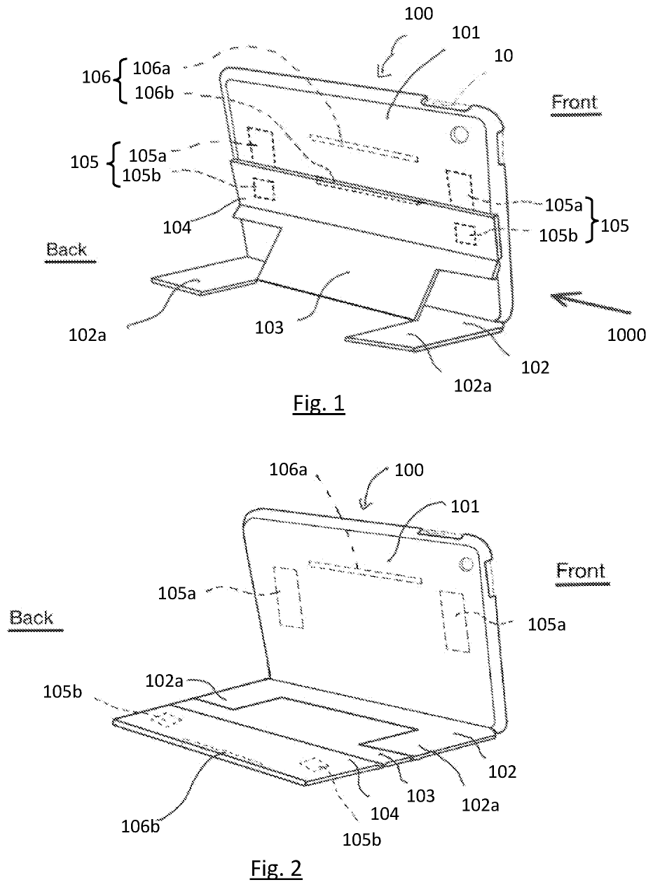

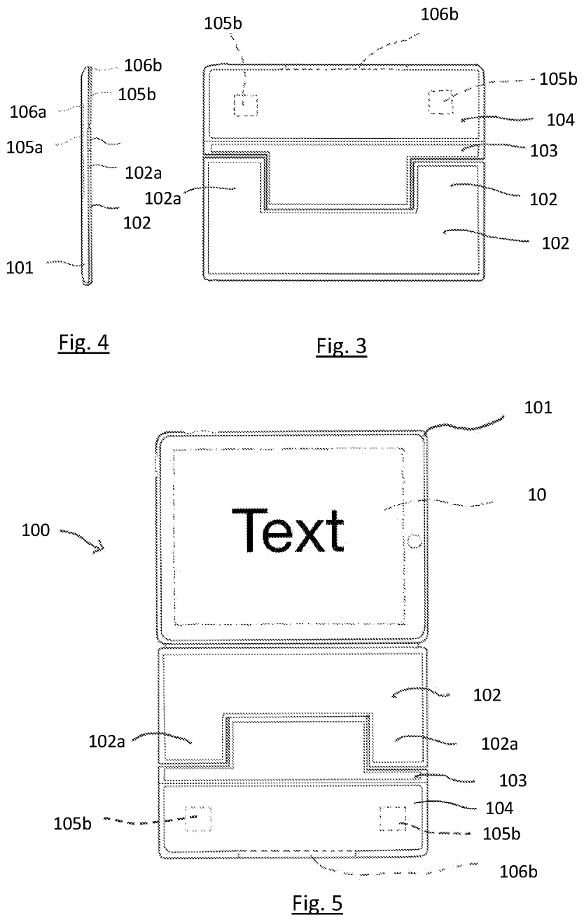

The present invention discloses an adjustable protective device 100 for smartphone and tablets comprising a protective case 101 and a foldably connected screen cover. The protective case 101 and screen cover are foldably connected with each other to enable covering of a screen of the smartphone or tablet 10. The protective case 101 comprises an inner compartment and an outer portion. The inner compartment accommodates a smartphone or tablet 10, and the outer portion is configured to have a plurality of raised-position support components 105 and 106. The protective case 101 and the screen cover are foldably connected, which refers to a foldable connection that provides an ability to be folded or bent while maintaining a functional connection. The folding or bending of the screen cover with respect to the protective case 101 allows a user to accomplish a close position (as shown in FIGS. 3 and 4) and an open position (as shown in FIG. 5). The folding of the screen cover also aids in supporting the outer portion or the back of the protective case 101 (as shown in FIGS. 1 and 2). The screen cover is fully collapsible to cover the screen of the smartphone or tablet 10. These foldable connections include but not limited to detent mechanism, locking mechanism and magnetic clasp or hinge mechanism for allowing rotation and holding rotational position set by the user in a secure manner until a certain deliberate force is applied to change the rotational position or release them.

Referring to FIG. 1-9, the preferred embodiment of the present invention discloses an adjustable protective device 100 for smartphones and tablets comprising of a protective case 101, a foldably connected screen cover including a base member 102, a supporting member 103 and a connecting member 104 along with a plurality of raised-position support components 105 and 106 including a primary raised-position support components 105a and 105b, and a secondary raised-position support components 106a and 106b.

FIGS. 1 and 2 illustrate an isometric view of the preferred embodiment of the present invention from the back, showing the folded screen cover supporting the back of the protective case 101 and an isometric view of the preferred embodiment of the present invention from the back, depicting laying orientation of the screen cover, respectively. The protective case 101 is to be utilized by the user for accommodating a gadget (smartphone and tablet) 10 that needs to be protected. The gadget 10 includes but not limited to smartphone and tablet 10. The protective case 101 is sturdy in nature, which makes that capable of protecting the gadget 10 from potential damage. The protective case 101 may be fabricated from a soft flexible material, such as synthetic leather, leather or a polymer-based fabric including nylon, polyester, or polymer-coated cotton and/or made up of one or more of the following plastic, fabric, cotton, elastic material, metal, wool, alloy, cotton, mixture and compound. Thereby, the disclosed invention allows the user to protect and personalize their electronic gadget 10.

Further, the foldably connected screen cover comprises plurality of members, which includes the base member 102, the support member 103 and the connecting member 104 that are foldably connected with each other to provide stability when used as a stand. The user is allowed to fold these members (base member 102, support member 103 and connecting member 104) at multiple angles up to 360 degrees in order to accomplish desired viewing or typing angle. The base member 102, the support member 103 and the connecting member 104 are foldably connected to each other via a plurality of fold lines. The protective case 101 and the base member 102, the base member 102 and the support member 103, and the support member 103 and the connecting member 104 are connected via a first fold line, a second fold line and a third fold line, respectively. The plurality of fold lines of the screen cover allows adjustability of a wide range of viewing angles for the protective case 101.

According to FIG. 1, the screen cover having the base member 102, support member 103 and connecting member 104 are folded in such a way that they form a triangular structure with respect to the back of the protective case 101 in view of providing support to the protective case 101 to achieve a standing position. The base member 102 comprises at least one stabilizer extension(s) 102a that provides additional support to the protective case 101, when positioned in a standing orientation (as shown in FIG. 1). In one of the embodiments, the base member 102 is configured with a pair of stabilizer extensions 102a, each positioned at sides of the base member 102. When the screen cover collapse, the area of the stabilizer extensions 102a of the base member 102 mates with the area of the support member 103 to enable lying of the screen cover flat on a table. Similarly, FIG. 2 shows the cover portion folded in backward direction, lying flat on the table, which supports the protective case 101 at standing position attaining a certain viewing angle.

Additionally, the at least one stabilizer extension(s) 102a is configured with the base member 102 for providing a greater stability for a raised position of the protective case 101. The stabilizer extension 102a also prevents tripping of the protective case 101, in case, the protective case 101 is orientated at a standing position or any viewing angle.

Referring to FIGS. 3 and 4 a front view of the screen cover with the screen cover at closed position of the preferred embodiment of the present invention and a side view of the preferred embodiment of the present invention with the screen cover at closed position are illustrated, respectively. In case, the user folds the screen cover over the protective case 101, indicating the closed position (as shown in FIGS. 3 and 4), the screen cover protects the gadget 10 accommodated within the protective case 101 from the scratches, dents and other similar damages (as shown in FIGS. 3 and 4).

Referring to FIG. 5, a front view of the preferred embodiment of the present invention with the screen cover at an open position is illustrated. The figure shows the clear view of the gadget 10 accommodated within the protective case 101 along with the first, second and third member, namely, the base member 102, the support member 103 and the connecting member 104, respectively.

According to the preferred embodiment of the present invention, the invention further discloses the plurality of raised-position support components 105 and 106 comprising the primary raised-position support components 105 and the secondary raised-position support components 106. The primary raised-position support components 105 further consists of a magnet(s) 105a and magnet-attractable part(s) 105b or vice versa. Herein, the back of protective case 101 is configured with a magnet(s) 105a that is to be engaged with a magnet-attractable part(s) 105b embedded within the connecting member 104 to attain the standing position of the protective case 101 (as shown in FIG. 1). The plurality of raised-position support components 105 and 106 configured in the protective case 101 and the connecting member 104 allows adjustability of the wide range of viewing angles of the protective case 101 by changing contact point of the plurality of raised-position support components 105 and 106 of the connecting member 104 and the protective case 101.

The plurality of raised-position support components 105 and 106 includes but not limited to magnets, magnet-attractable parts, hook and loop fasteners, protrusion and pocket engagement, and edge and groove engagement. In one embodiment of the present invention, the plurality of raised-position support components 105 and 106 comprises a pair of vertical magnets and/or a horizontal magnet on a back side of the protective case 101, and a pair of vertical magnets and/or a horizontal magnet in the connecting members 104.

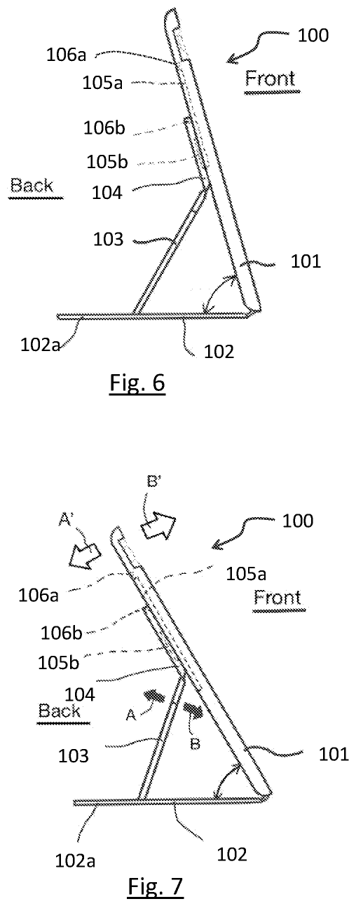

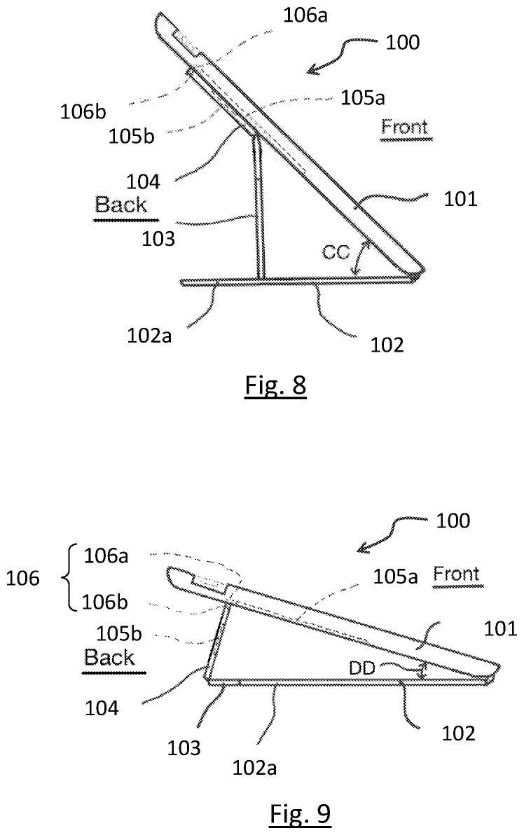

Referring to FIG. 6-9, a side view of the folded cover portion supporting the back of the protective case 101 providing different viewing angle of the preferred embodiment of the present invention is illustrated. The user can achieve wide-range of viewing angle by changing point of contact of the magnet(s) 105a and magnet-attractable part(s) 105b (as shown in FIG. 6, FIG. 7 and FIG. 8). In an exemplary embodiment of the present invention, the plurality of raised-position support components 105 may comprise the magnet(s) 105a embedded within the connecting member 104 and magnet-attractable part(s) 105b in the protective case 101. In another exemplary embodiment of the invention, the plurality of raised-position support components 105 comprise of the magnet(s) 105a embedded within the connecting member 104 and magnet(s) 105a in the protective case 101. Referring to FIG. 6, a side view of the folded cover portion supporting the back of the protective case 101 providing a viewing angle of the preferred embodiment of the present invention is illustrated. The protective case 101 is orientated at standing position with support of the plurality of members. Herein, the base member 102 along with the pair of stabilizer extension 102a is lying flat on the table, the support member 103 is folded to form a triangular structure with the base member 102 and the protective case 101, and the connecting member 104 is attached on the back of the protective case 101 via the plurality of raised-position support component(s) 105a and 105b to provide stability to the protective case 101. The pair of stabilizer extension 102a prevents tripping back of the protective case 101.

Referring to FIG. 7, the bending of the support member 103 in the direction of A in accordance with the black arrow, leads to tilting of the top of the protective case 101 towards the white arrow A′ direction and similarly in case, the user bends the support member 103 in the direction of B according to the black arrow, the top of the protective case 101 moves to the white arrow B′ direction. FIG. 7 represents the smaller angle formed between the protective case 101 and the base member 102 in comparison to FIG. 6 in view of providing different viewing angle to the user. Similarly, FIG. 8 represents the smaller angle formed between the protective case 101 and the base member 102 in comparison to FIG. 7 in view of providing another different viewing angle (as represented by CC) to the user. Herein, the connecting member 104 is attached on the back of the protective case 101 via the plurality of raised-position support component(s) 105 and 106 to provide stability to the protective case 101. The primary raised-position support components 105a and 105b and the secondary raised-position support components 106a and 106b both mates to form a stable connection between the connecting member 104 and the protective case 101 in order to provide support to the back of the protective case 101, positioned at this particular viewing angle (CC). FIG. 9 represent the further smaller angle formed between the protective case 101 and the base member 102 in comparison to FIG. 8 in view of providing a typing angle (as represented by DD) to the user.

Referring to FIG. 9, the preferred embodiment of the present invention discloses the secondary raised-position support components 106 that consist of a magnet(s) 106a and a magnet-attractable part(s) 106b, which applies to the typing angle setting. Herein, the back of the protective case 101 is configured with a magnet(s) 106a that is to be attached with a magnet-attractable part(s) 106b embedded within the connecting member 104 to attain the typing angle setting (as shown in FIG. 9). When the magnet(s) 106a and the magnet-attractable part(s) 106b make contact, the connecting member 104 and the protective case 101 gets locked, preventing any further change in typing angle set by the user (as shown in FIG. 9) until a certain deliberate force is applied.

In an exemplary embodiment of the invention, the raised-position support component 106 comprises of the magnet(s) 106a embedded within the connecting member 104 and magnet-attractable part(s) 106b in the protective case 101. In another exemplary embodiment of the invention, the raised-position support component 106 comprises of the magnet(s) 106a embedded within the connecting member 104 and the magnet(s) 106a in the protective case 101. The magnet(s) is also allowed to be molded in the protective case 101 and the connecting member 104 or attached to the protective case 101 and the connecting member 104 by the method known in the industry.

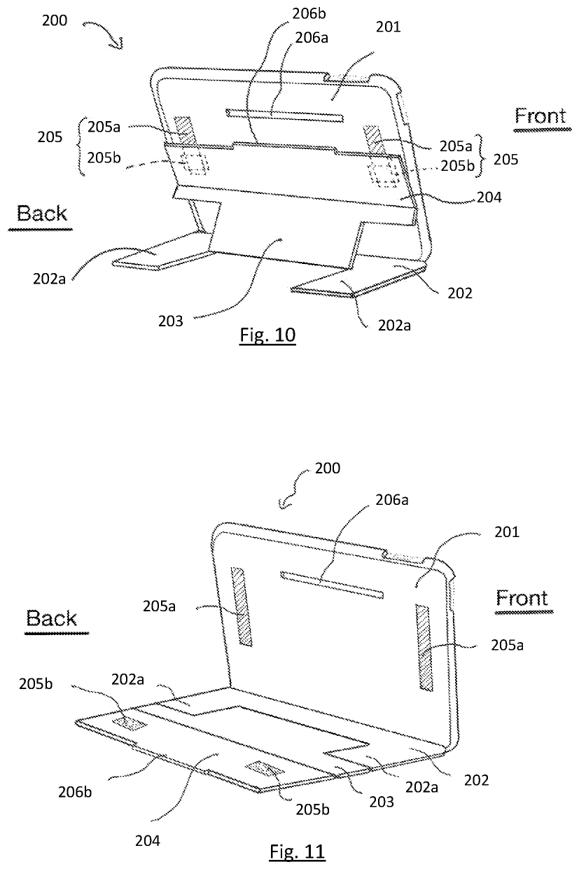

FIG. 10-14 illustrates the first alternate embodiment of the present invention, a protective device 200 for tablet or smart phone is disclosed comprising a plurality of raised-position support components 205 utilizing a hook and loop fasteners. The hook and loop fasteners are attached to the protective case 201 and a connecting member 204 by the method known in the industry. The hook and loop fastener comprises of a hook fastener 205a and a loop fastener 205b.

Referring to FIG. 10, an isometric view of the first alternate embodiment of the present invention 200, depicting the folded cover supporting the back of the protective case is illustrated. Herein, the back of the protective case 201 is configured with a hook fastener 205a that is to be engaged with a loop fastener 205b attached with the connecting member 204 by the user to attain the desirable standing position of the protective case 201. In an exemplary embodiment of the present invention, the raised-position support components 205 consist of the hook fastener 205a attached with the connecting member 204 and loop fastener 205b to the protective case 201. According to FIG. 10, the screen cover having a base member 202, a support member 203 and the connecting member 204, are folded in such a way that they form a triangular structure with respect to the back of the protective case 201 in view of providing support to the protective case 201 to achieve a standing position. The base member 202 comprises at least one stabilizer extension(s) 202a that provides additional support to the protective case 201, when positioned in a standing orientation. In one of the embodiments, the base member 202 is configured with a pair of stabilizer extensions 202a, each positioned at sides of the base member 202. When the screen cover collapses, the area of the stabilizer extensions 202a of the base member 202 mates with the area of the support member 203 to enable lying of the screen cover flat on a table (as shown in FIG. 11).

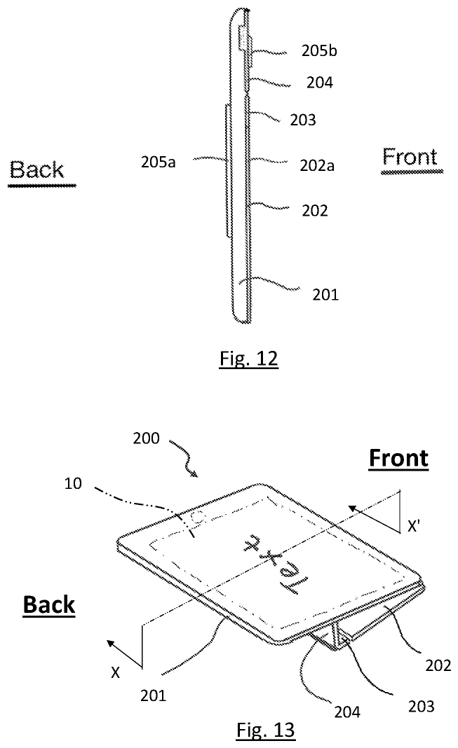

Referring to FIGS. 11 and 12, an isometric view of the first alternate embodiment of the present invention, indicating the cover portion lying flat on a table and a side view of the first alternate embodiment of the present invention in closed position, are illustrated.

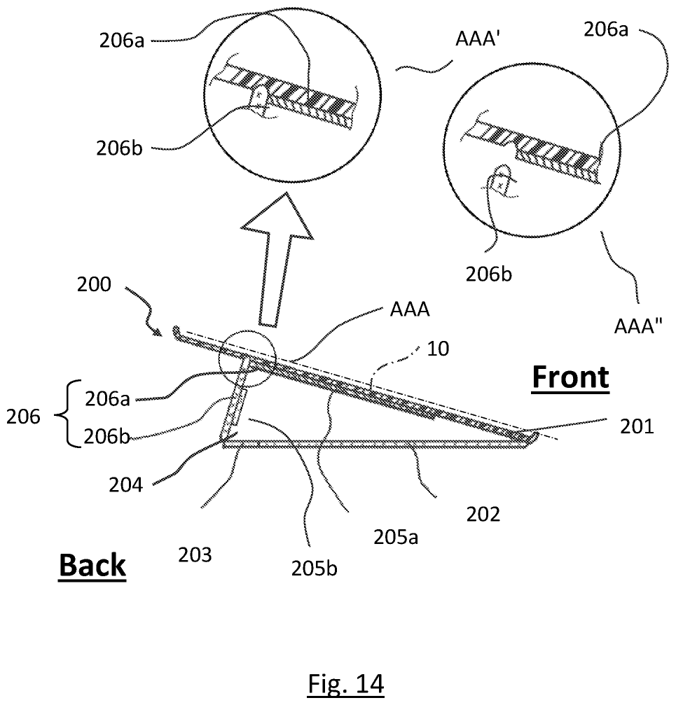

Referring to FIG. 13, an isometric view of the first alternate embodiment of the present invention at typing angle is illustrated. The present invention discloses the plurality of raised-position support component 206 consisting of a pocket 206a and protrusion 206b that applies to the typing angle setting. The plurality of protrusions 206b is on the connecting member 204 and the plurality of pockets 206a is on a back side of the protective case 201. In case, the user desires to position the protective case 201 at typing angle, the user is required to engage the protrusion 206b within the pocket 206a, which locks the connecting member 204 and the protective case 201, preventing change in angle set by the user (as shown in FIGS. 13 and 14). The viewing angle is obtained by inserting at least a pair of the plurality of protrusions 206b in the at least a pair of the plurality of pockets 206a. This concept of the raised-position support components also applied to other alternate embodiments of the present invention.

Referring to FIG. 14 a cross section x-x′ shown in FIG. 13 is illustrated. The figure represents the circled area AAA′ and AAA″ that is exploded view of circle, AAA, wherein the circle AAA′ shows the engagement of the protrusion 206b within the pocket 206a and the circle AAA″ shows the protrusion 206b and the pocket 206a prior to the engagement.

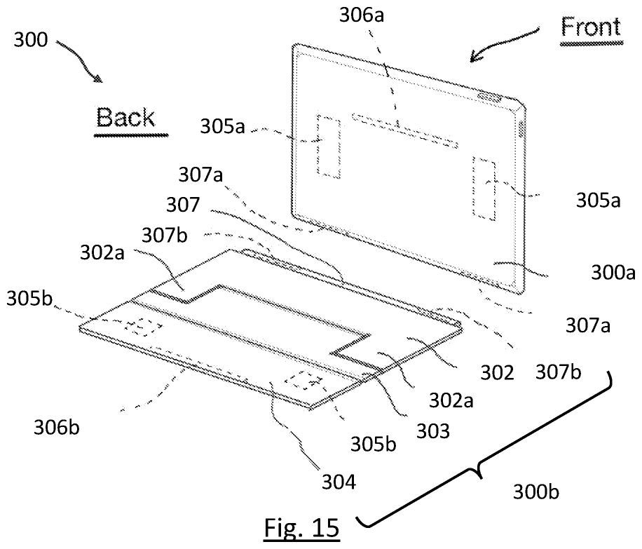

FIGS. 15 and 16 illustrate a second alternate embodiment of the present invention 300 discloses a screen cover 300. The screen cover 300 is attachable to smart phone or a tablet through at least a lip 307. The lip 307 is a narrow portion along the length of the base member wherein magnet or magnet attachable part 307b are configured by means of which the screen cover 300b is attached to the smartphone or tablet 300a at magnet or magnet attachable part 307a. Therefore, the screen cover 300b is detachably attached to the smartphone or tablet 300a and also the screen cover 300b is two-ways foldable. FIG. 15 represents the tablet 300a and the screen cover 300b separately. The lip 307 allows direct attachment of the screen cover 300b with the smartphone or the tablet 300a. In one of the embodiments, the plurality of raised-position support components 305a/306a and 305b/306b is configured in the smartphone or the tablets 300a. In other embodiment, the plurality of raised support components 307a and 307b may be configured at an edge of the tablet 300a/the smartphone 300a/the protective case 300a and an edge of the screen cover 300b, respectively, which make corresponding pairing for strong attachment. The plurality of raised-position support components 305a/306a and 305b/306b configured in the connecting members 304 allows adjustability of the wide range of viewing angles to the smartphone or the tablet 300a by means of the at least one lip 307 configured in the screen cover 300b. A magnet(s) 307a embedded at an edge of the tablet and a magnet(s) 307b embedded at an edge of the screen cover 300b in the lip 307, facing towards the edge of the smartphone or tablet 300a. In an alternative embodiment, the smartphone or tablet 300a may be substituted by the protective case 300a and the lip 307 may be attached to the protective case 300a. Therefore, the protective case 300a may comprise magnet(s) 307a and the screen cover 300b may comprise of the magnet(s) 307b. In the embodiment, the base 302 has an extension stabilizer 302a and a support member 303 and a connecting member 304.

FIG. 16 represents the second alternate embodiment from the typing angle. The raised-position support components 306 may comprise of a magnet(s) 306a and a magnet-attractable part(s) 306b, which applies to the typing angle setting. Herein, the back of the protective case 301a is configured with a magnet(s) 306a that is to be attached with a magnet-attractable part(s) 306b embedded within the connecting member 304 to attain the typing angle setting.

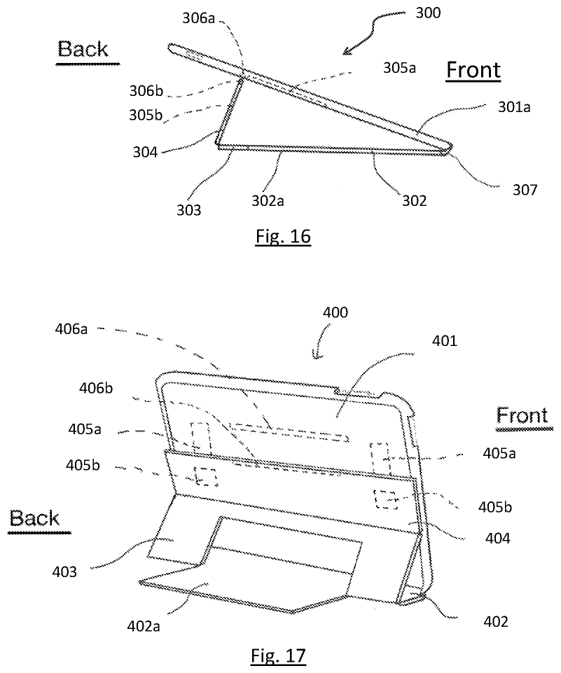

According to a third alternate embodiment of the present invention 400, as shown in FIG. 17 that illustrates an isometric view of the third alternate embodiment of the present invention. The adjustable protective device 400 comprises a protective case 401 and a screen cover comprising a plurality of members including a base member 402, a support member 403 and a connecting member 404. The connective member 404 may comprise a plurality of raised support component 405b, 406b which respectively pair with raised support components of 405a, 406a of the protective case 401. The embodiment may comprise an alternate design of the stabilizer extension 402a on the base member 402. The stabilizer extension 402a is present at the center of the base member 402. In the embodiment, the stabilizer extension 402a is an extension having a width and a length that mates with the area in the support member 403 when the screen cover is collapsed.

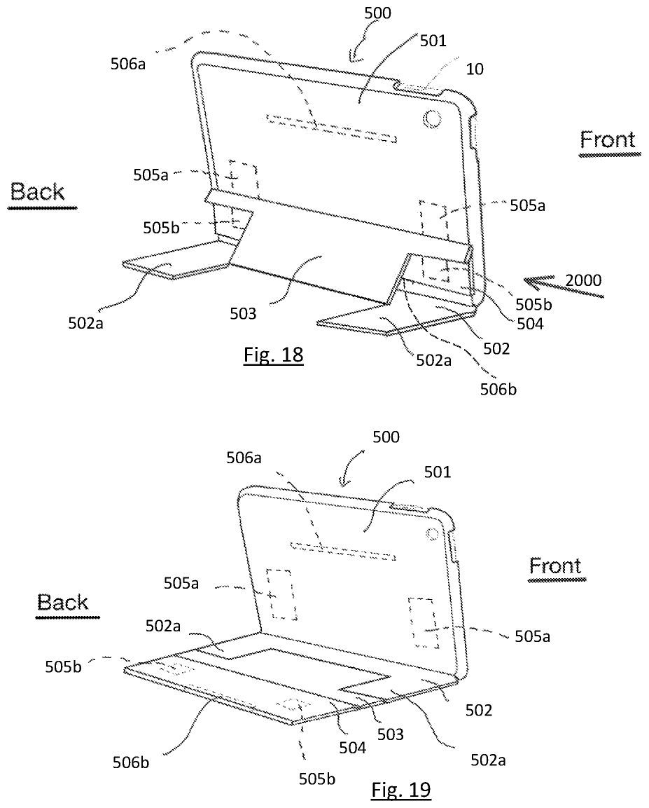

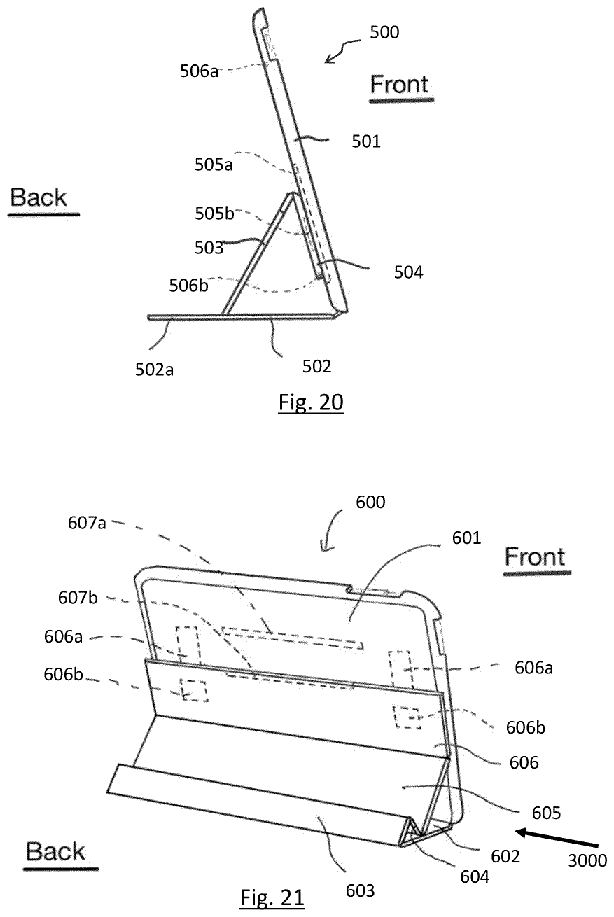

FIG. 18-20 illustrates a fourth alternate embodiment of the present invention 500 that discloses an alternate folding direction of a connecting member 504. The connecting member 504 is folded downwards to meet with a protective case 501 (as directed by an arrow 2000) and connected together with the raised-position support components 505a and 505b configured at the protective case 501 and connecting member 504 respectively for providing stability to the protective case 501 at the standing position (as shown in FIG. 18). FIG. 19 shows the cover portion folded in backward direction, lying flat on a table, which supports the protective case 501 at standing position attaining a certain viewing angle. FIG. 20 shows the side view of FIG. 18.

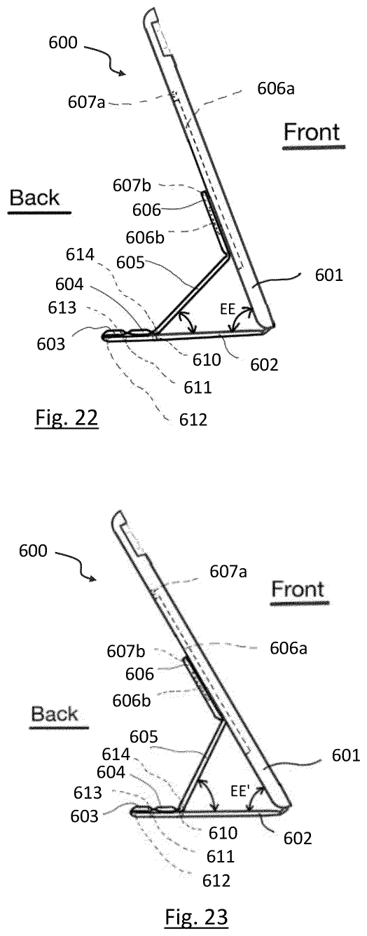

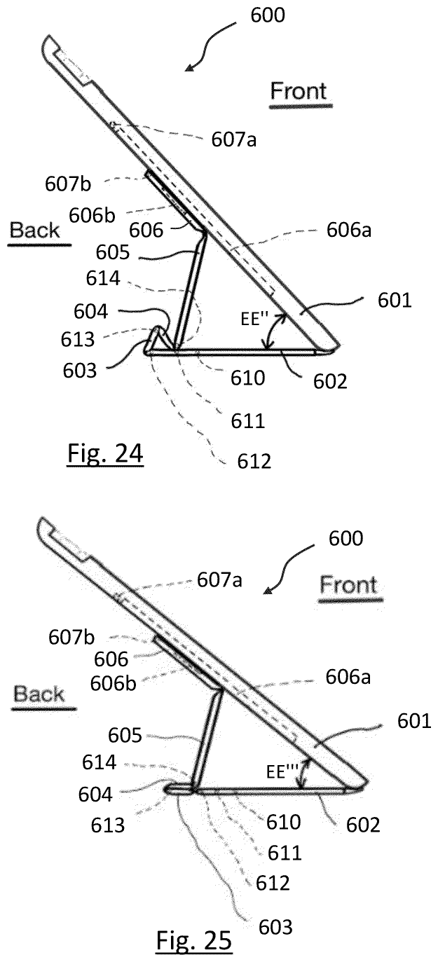

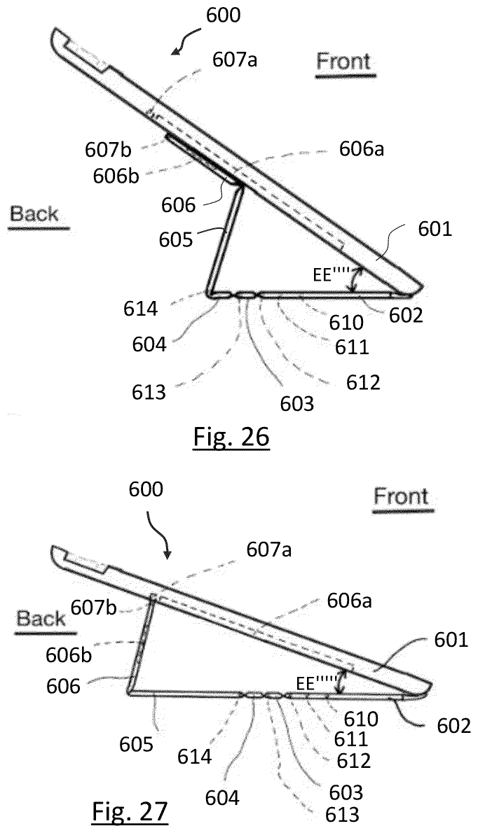

According to a fifth alternate embodiment of the present invention, an adjustable protective device for smartphones and tablets 600, as illustrated in FIG. 21-27 is disclosed. The protective device 600 comprises a first additional member 603 and second additional member 604. The base member 602, the first additional member 603, the second additional member 604, the support member 605 and the connecting member 606 constitute the screen cover and folded in a manner to provide support to the back of the protective case 601 that offers different viewing angle EE, EE′, EE″, EE′″, EE″ “, EE”′ (as shown in FIG. 22-27). Each and every member is connected with each other through a foldable connection. The foldable connection achieved here is through the magnet(s) and/or the magnet-attractable part(s) and the same applies to a sixth, seventh, eighth and ninth embodiment of the present invention.

In the embodiment of the present invention, the screen cover of the adjustable protective device comprises of at least one additional member between the base member 602 and the support member 605. In another aspect of the embodiment comprises at least two additional members including the first additional member 603 and the second additional member 604.

The fifth embodiment further discloses the magnet(s) and/or the magnet-attractable part(s) at different locations and in different numbers represented through 606a, 606b, 607a, 607b, 610, 611, 612, 613 and 614 (as shown in FIG. 22-27). In an aspect of the present invention, the location and number of the magnet(s) and/or the magnet-attractable part(s) is allowed to be adjusted. In the embodiment, the magnet support components 610, 611, 612, 613 and 614 may be configured along the edges of the fold lines between the members of the screen cover.

In an embodiment of the present invention, the additional members are allowed to be omitted or added between the base member 602 and the support member 605.

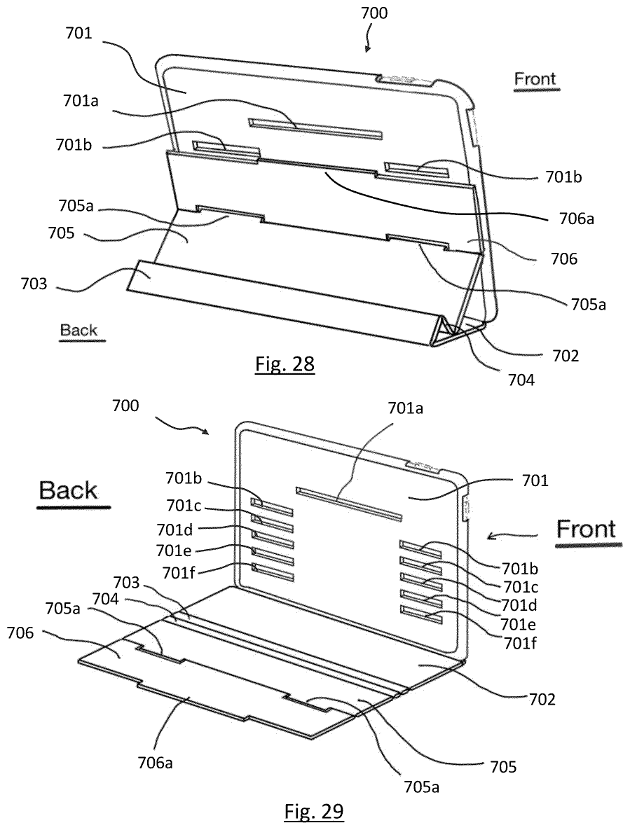

Referring to FIGS. 28 and 29 that illustrates the sixth embodiment of the present invention 700, which discloses presence of a tab(s) 705a and 706a on the supportive member 705 and connecting member 706, respectively along with plurality of slots 701a, 701b, 701c, 701d, 701e, and 701f crafted on the protective case 701. The user is allowed to engage the tab(s) 705a and 706a of the supportive member 705 and connecting member 706, in different slots 701a, 701b, 701c, 701d, 701e, and 701f crafted on the protective case 701 to obtain different viewing and typing angles. In case, the user engages the tab(s) 706a within the slot 701a, the protective case 701 bends to offer the typing position. Herein, the screen cover also provided with the at least one additional member (as represented by 703 and 704) that are folded in different manner to obtain different viewing and typing angle.

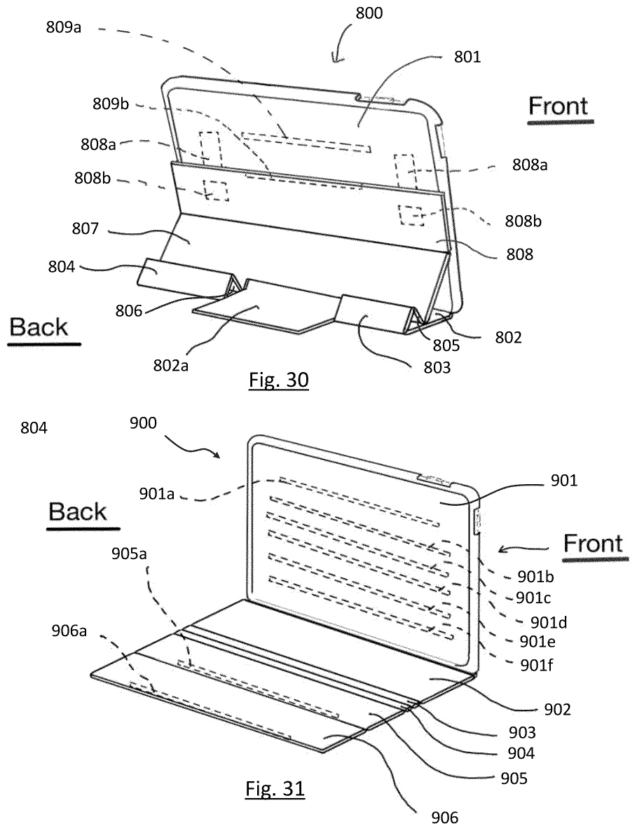

Referring to FIG. 30, the seventh embodiment of the present invention 800 discloses the presence of a pair of first additional member 803 and second additional member 804 along with the stabilizer extension 802a on the base member 802. The seventh alternate embodiment of the present invention consists of the protective case 801, base member 802, the pair of first additional members 803 and 804, the pair of second additional members 805 and 806, the support member 807 and the connecting member 808 that are foldably connected with each other. FIG. 30 shows a structure that is obtained from folding the base member 802, pair of first additional members 803 and 804, pair of second additional members 805 and 806, the support member 807 and the connecting member 808. Wherein, the stabilizer extension 802a is present at the center of the base member 802 for additional support to the protective case 801. Herein, the plurality of raised-position support components 808b, 809b respectively pair with 808a, 809b to provide engagement to form a connection between the connecting member 808 and the protective case 801 while used a stand.

According to the eighth embodiment of the present invention 900, as illustrated in FIG. 31 discloses different layout and numbers of the magnet(s) 901a, 901b, 901c, 901d, 901e and 901f on the protective case 901 that are to be connected with the magnet-attractable part(s) 905a and 906a present on the supporting member 905 and connecting member 906. The numbers of magnets are allowed to be adjusted. The base member 902 and the additional members 903 and 904 are configured in the screen cover that are lying flat on the table to provide support to the protective case 901 at a standing position.

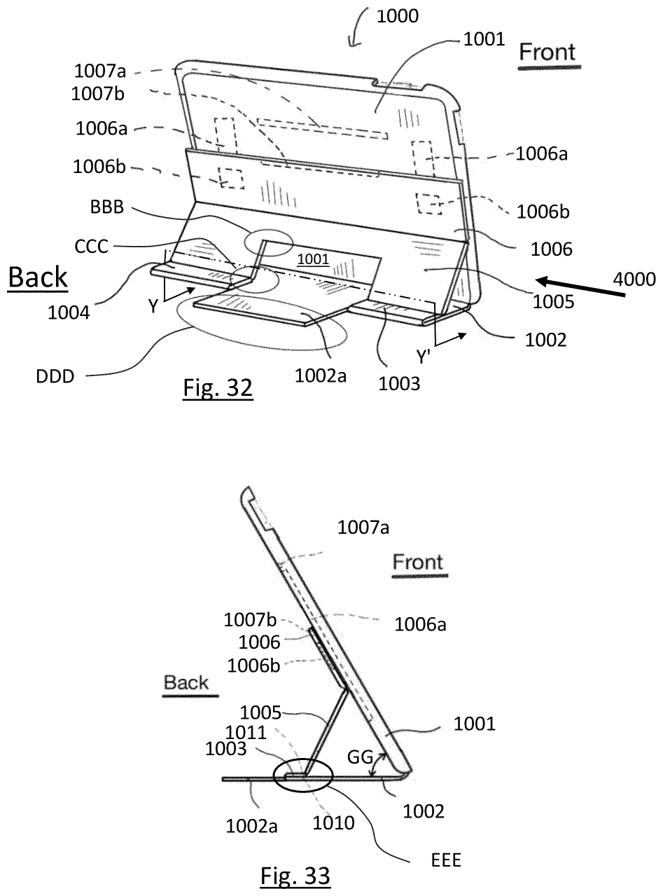

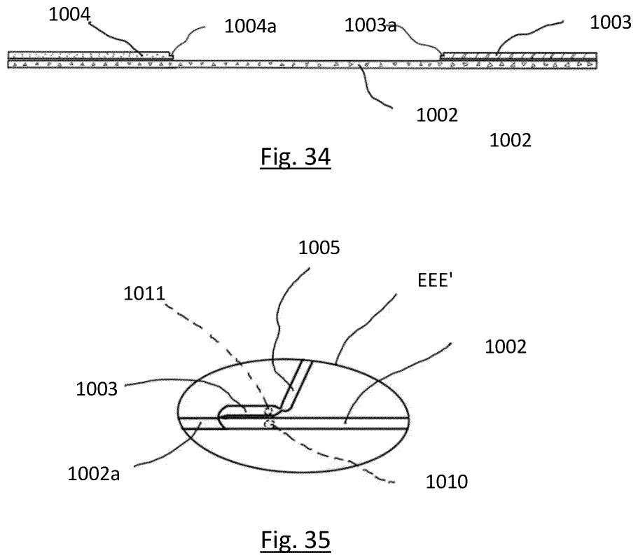

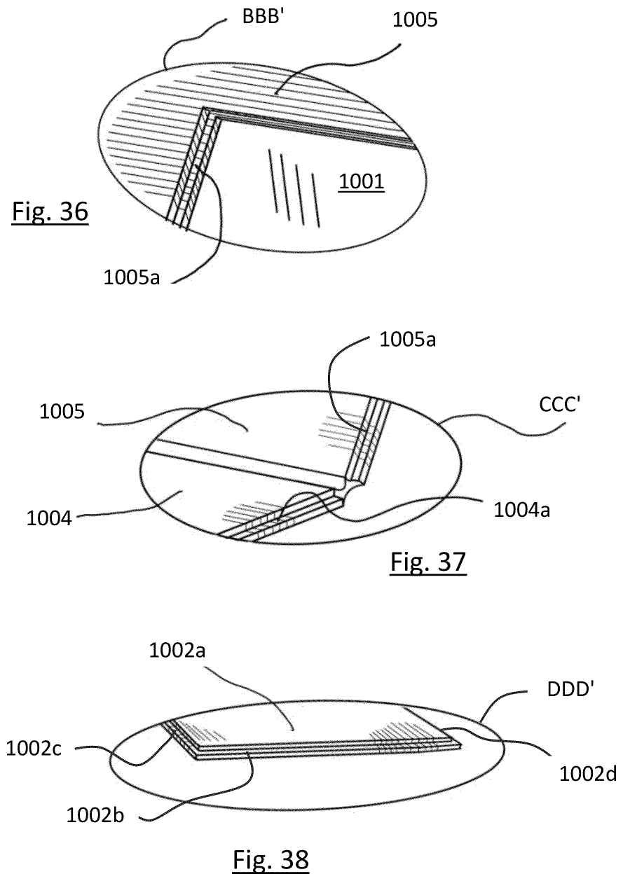

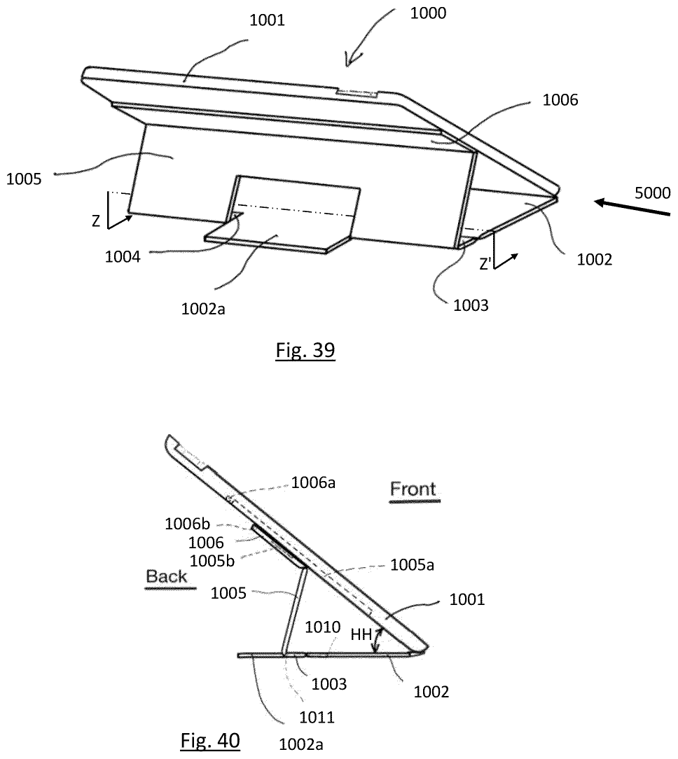

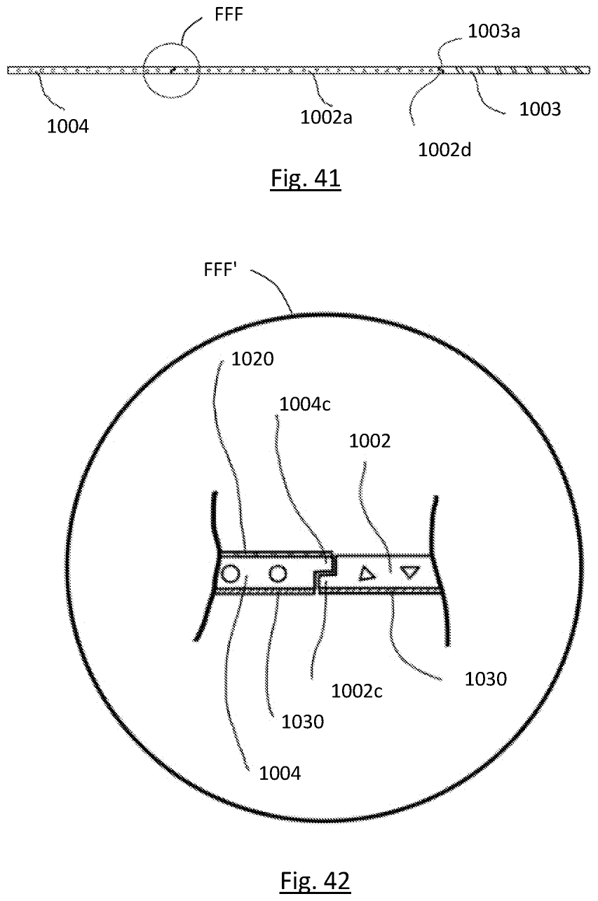

According to the ninth alternate embodiment of the present invention, an adjustable protective device 1000, as illustrated in FIG. 32-43, is disclosed. The device 1000 comprises a protective case 1001, a base member 102, a stabilizer extension 1002a at the center of base member 1002 which perimeter mates with a pair of additional members 1003 and 1004, support member 1005 within the body. The stabilizer extension 1002a comprises a portion DDD, CCC, BBB which are interlocking steps. The interlocking step BBB 1005a is configured in the support member 1005, CCC 1003a and 1004a in the side of the pair of additional members, and DDD 1002b, 1002c and 1002d are configured along the perimeter of the extension stabilizer 1002a. The interlocking steps 1002c and 1002d mate with steps of the pair of additional members 1003a and 1004a, and 1002b mates with 1005a of the support member, wherein the plurality of interlocking steps prevent tripping while matting with additional and support member. In the embodiment, the interlocking steps 1002c and 1002d has to be engaged with interlocking steps 1004a and 1003a present on the additional member 1004 and 1003, respectively (as shown in FIG. 41). Referring to FIG. 32, an isometric view of the ninth alternate embodiment of the present invention, indicating the folded screen cover supporting the back of the protective case 1001. The ninth alternate embodiment of the present invention consist of a protective case 1001, a base member 1002 having interlocking steps 1002b, 1002c, and 1002d (as shown in FIGS. 32 and 38, denoted by DDD and DDD′), a pair of additional members 1003/1004 having interlocking steps 1003a/1004a, a support member 1005 having interlocking step 1005a (as shown in FIGS. 32 and 36, denoted by BBB and BBB′), and a connecting member 1006 that are foldably connected with each other. The stabilizer extension 1002a forms a double rabbet or scarf type interlocking while the interlocking steps 1002b, 1002c, and 1002d of the stabilizer extension 1002a mates with the interlocking steps 1003a/1004a of the plurality of additional members 1003/1004 and the interlocking step 1005a of the support member 1005.

In an embodiment of the present invention, the at least one stabilizer extension 1002a forms an interlocking with the interlocking steps 1003a/1004a of the plurality of additional members 1003/1004 and/or the interlocking step 1005a of the support member 1005 to prevent flipping of the stabilizer extension 1002a against the support member 1005 and/or the additional members 1003/1004 at the point of mating. The interlocking is chosen from the double rabbet or scarf type interlocking.

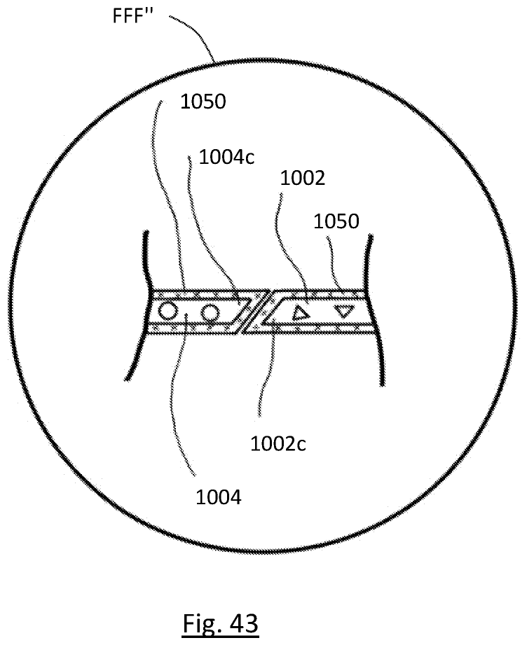

The double rabbet interlocking is shown in FIG. 42 and the scarf type interlocking is shown in FIG. 43. The presence of interlocking steps is applicable for all the alternate embodiments that constitute presence of additional members between the base member 1002 and the support member 1005. The base member 1002 and pair of additional members 1003/1004 are configured with a magnet(s) and magnet-attractable part(s) in view of attracting each other (as shown in FIG. 33, and FIG. 35, denoted by EEE and EEE′).

New characteristics and advantages of the invention covered by this document have been set forth in the foregoing description. It is to be expressly understood, however, that the expressions used in foregoing are for the purpose of illustration only and are not intended as a definition of the limits of the invention. Changes in the specification are capable of being made in detail without exceeding the scope of the invention by those who are skilled in the art. The scope of the invention is described in the appended claims hereinafter.

What is claimed is:

1. An adjustable protective device for smartphones and tablets, the device comprising:
a protective case comprising an inner compartment and an outer portion;
a foldably connected screen cover for covering a screen of the smartphone or tablet;
the screen cover comprises a plurality of members;
the plurality of members includes:
a base member;
a support member; and
a connecting member;
wherein the base member, the support member and the connecting member are foldably connected to each other via a plurality of fold lines;
wherein the plurality of fold lines of the screen cover allows adjustability of a wide range of viewing angles for the protective case and a greater stability at a raised position of the protective case;
the outer portion of the protective case and at least one plurality of members are configured with a plurality of raised-position support components.

2. The device as claimed in claim 1, wherein the screen cover further comprises at least one additional member between the base member and the support member.

3. The device as claimed in claim 1, wherein the plurality of members further comprises at least two additional members including a first additional member and a second additional member.

4. The device as claimed in claim 1, wherein the base member comprises at least one stabilizer extension which allows greater stability to the protective case.

5. The device as claimed in claim 1, wherein the screen cover is detachable from the protective case through at least a lip.

6. The device as claimed in claim 5, wherein the screen cover is attachable to a smart phone or a tablet through the at least a lip.

7. The device as claimed in claim 1, wherein the plurality of raised-position support components includes magnets, magnet-attractable parts, hook and loop fasteners, protrusion and pocket engagement, and edge and groove engagement.

8. The device as claimed in claim 1, wherein the plurality of raised-position support components is configured in the plurality of members including additional members and the protective case to allow adjustability of the wide range of viewing angles.

9. The device as claimed in claim 1, wherein the plurality of raised-position support components is configured along the edges of the fold lines of the plurality of members including additional members.

10. The device as claimed in claim 1, wherein the viewing angle of the protective case is adjusted by changing at least a contact point of the plurality of raised-position support components of the plurality of members on the outer portion of the protective case.

11. The device as claimed in claim 1, wherein a plurality of protrusions is on the connecting member and a plurality of pockets is on the outer portion of the protective case.

12. The device as claimed in claim 11, wherein the viewing angle is obtained by inserting at least a pair of the plurality of protrusions in the at least a pair of the plurality of pockets.

13. The device as claimed in claim 1, wherein the plurality of raised-position support components of the protective case and the connecting member of the screen cover forms corresponding pairing to form the raised position.

14. The device as claimed in claim 4, wherein the at least one stabilizer extension forms an interlocking with the plurality of additional members and/or the support member to keep the stabilizer extension on the same plane as the base member and/or the additional members exists.

15. The device as claimed in claim 14, wherein the support member is always above the plane of the stabilizer extension to provide strong standing support to the device for stable viewing angle.

16. The device as claimed in claim 14, wherein the interlocking is chosen from double rabbet or scarf type interlocking.

17. The device as claimed in claim 1, wherein the connecting member has an edge, and the outer portion of the protective case has a groove line; the edge inserted into the groove line to stabilize the protective case to achieve typing angle.

18. An adjustable protective device for smartphones and tablets, the device comprising:
a protective case comprising an inner compartment and an outer portion;
a foldably connected screen cover for covering a screen of the smartphone or tablet;
the screen cover comprises a plurality of members;
the plurality of members includes:
a base member;
a support member;
a connecting member;
a first additional member and a second additional member;
wherein the plurality of members is foldably connected to each other via a plurality of fold lines;
wherein the plurality of fold lines of the screen cover allows adjustability of a wide range of viewing angles for the protective case;
wherein at least one stabilizer extension is configured in the base member which allows stability at a raised position to the protective case;
the outer portion of the protective case and the at least one plurality of members are configured with a plurality of raised-position support components;
wherein the plurality of raised-position support components includes magnets, magnet-attractable parts, hook and loop fasteners, protrusion and pocket engagement, and edge and groove engagement;
wherein the at least one stabilizer extension forms an interlocking with the plurality of additional members and/or the support member to keep the support member always above a plane of the stabilizer extension;
wherein the interlocking is chosen from double rabbet or scarf type interlocking.

19. The device as claimed in claim 18, wherein a magnet strip is configured along the fold lines along the edges of the plurality members.

20. A screen cover for covering a screen of the smartphone or tablets, the screen cover comprises:
a plurality of members;
the plurality of members includes:
a base member;
a support member; and
a connecting member;
wherein the base member, the support member and the connecting member are foldably connected to each other via a plurality of fold lines;
wherein the plurality of fold lines of the screen cover allows adjustability of a wide range of viewing angles for the screen of the smartphone or tablets and a greater stability for a raised position of the screen of the smartphone or tablets;
the connecting members are configured with a plurality of raised-position support components;
wherein the plurality of raised-position support components configured in the connecting members allows adjustability of the wide range of viewing angles to a smartphone or tablet by means of at least a lip configured in the screen cover;
wherein a plurality of raised-position support components is configured in the smartphone or tablets,
wherein the lip is configured with a magnet or magnet attachable parts along the length of the lip.
